(19) United States
(12) Patent Application Publication
(10) Pub. No.: US 2022/0250069 A1
(43) Pub. Date: Aug. 11, 2022

(54) METHOD FOR LOADING A MULTIPLEXED ARRAY OF NANOLITER DROPLET ARRAY DEVICES

(71) Applicant: Nanosynex Ltd, Tel Aviv (IL)

(72) Inventors: Shulamit LEVENBERG, Moreshet (IL); Hagit STAUBER, Haifa (IL); Jonathan AVESAR, San Diego, CA (US); Micha ROSEN, Tzur Hadassah (IL)

(73) Assignee: Nanosynex Ltd, Tel Aviv (IL)

(21) Appl. No.: 17/622,251

(22) PCT Filed: Jun. 29, 2020
(86) PCT No.: PCT/IL2020/050722

§ 371 Date: Dec. 23, 2021

Related U.S. Application Data
(60) Provisional application No. 62/869,022, filed on Jun. 30, 2019.

(51) Int. Cl. B01L 3/00

(52) U.S. Cl. CPC B01L 3/502753; B01L 2200/027; B01L 2200/0642; B01L 2200/0684; B01L 2400/049; B01L 2300/0864; B01L 2300/0893; B01L 2300/0896; B01L 2300/14; B01L 2300/0819

(57) ABSTRACT

Microfluidic devices and methods thereof; the devices including: SNDA components; each SNDA component comprising: a primary channel; secondary channels; and nano-wells that are each open to the primary channel and are each connected via vents to the secondary channel; the vents are configured to enable passage of gas solely from the nano-wells to the secondary channel, such that when a fluid is introduced into the primary channel it fills the nano-wells, and the originally accommodated gas is evacuated via the vents and the secondary channel/s; a common inlet port, configured to enable a simultaneous introduction of the fluid into all the primary channels of the different SNDA components; individual inlet ports, configured to enable individual introduction of fluid, each into a different primary channel of a different SNDA component; and at least one outlet port, configured to enable evacuation of the gas out of all the secondary channels.

### FIELD OF THE INVENTION

The present invention relates to a method for loading microfluidic devices. More particularly, the present invention relates to a method for loading a multiplexed array of nanoliter droplet array devices.

### BACKGROUND OF THE INVENTION

Microfluidic devices that are designed to hold nanoliter-sized droplets of liquids in separate nano-wells, referred to herein as a stationary nanoliter droplet array (SNDA) devices, have been proven to be of use in the execution of various biological and chemical tests and procedures. In a typical procedure, two or more fluids are introduced successively into the device via one or more inlets. The nano-wells are then examined, e.g., visually by a microscope, by an automated image analysis system or otherwise, to determine results of any interactions between the successively introduced liquids or effects on cells that are suspended in one of the introduced liquids.

In a typical SNDA device, the introduced fluid may flow from the inlet into a primary channel of the device. The primary channel is lined on both sides by openings to nano-wells, where adjacent nano-wells are being separated from one another by walls. An end of each nano-well that is distal to its opening to the primary channel includes one or more vents that are opened to an air evacuation channel. Thus, as each nano-well is filled with liquid via its opening to the primary channel, air that had previously filled the nano-well escapes through its vent to the air evacuation channel. The openings of the vent are typically small enough so as to prevent the liquid from passing out of the nano-well through the vent. For example, the liquid may be prevented from emerging through the vent by the action of surface tension, viscosity, air pressure, or other forces. Thus, each nano-well may be partially or completely filled by the introduced liquid

For example, such SNDA devices have been employed successfully to perform antimicrobial susceptibility testing (AST). When an SNDA device is used for AST, an antibiotic liquid is first introduced into each of the nano-wells. In some cases, the antibiotic may be introduced into the nano-wells in a manner that produces a gradient of concentration of the antibiotic along the length of the primary channel. The antibiotic may be lyophilized or otherwise treated, e.g., to retain the antibiotic in the nano-wells. A bacterial suspension may then be introduced into the nano-wells. The nano-wells may then be examined to determine the effect of the antibiotic on the bacteria. For example, an image of the SNDA device may be analyzed, either by eye or by a processor, to determine the effect of the antibiotic on the bacteria.

### SUMMARY OF THE INVENTION

According to some embodiments of the invention a new microfluidic device is provided, comprising:
plurality of Stationary Nanoliter Droplet Array (SNDA) components; each SNDA component comprising:
   at least one primary channel;
   at least one secondary channel; and
   a plurality of nano-wells that are each open to the primary channel and are each connected via one or more vents to the secondary channel; the vents are configured to enable passage of gas solely from the nano-wells to the secondary channel, such that when a fluid is introduced into the primary channel it fills the nano-wells, and the originally accommodated gas is evacuated via the vents and the secondary channel/s;
a common inlet port, configured to enable a simultaneous introduction of the fluid into all the primary channels of the different SNDA components;
plurality of individual inlet ports, configured to enable individual introduction of fluid, each into a different primary channel of a different SNDA component; and
at least one outlet port, configured to enable evacuation of the gas out of all the secondary channels;
wherein at least one of the following holds true:
   the nano-wells comprise a neck opening configuration at the end, which is open towards the primary channel; and
   the vents of the nano-wells comprise a short and wide window-like configuration.

According to some embodiments, the nano-well's neck opening to the primary channel is characterized by a ratio between the area of the nano-well's opening (S_{LG}) and the area of the nano-well's walls (S_{SL}); the ratio is configured to reduce an energy barrier for a droplet shearing, such that a sheared fluid is retained as a droplet within said nano-well.

According to some embodiments, the ratio S_{LG}/S_{SL} is selected between about 0.4 and less than 1.0.

According to some embodiments, the device further comprising a distribution channel in fluid communication with the common inlet, configured to enable a simultaneous introduction of the fluid into all the primary channels of the different SNDA components.

According to some embodiments, the device further comprising an evacuation channel in fluid communication with the outlet port, configured to enable a simultaneous evacuation of the gas out of the secondary channels of the different SNDA components.

According to some embodiments, at least one of the inlets and outlets is configured to enable an application of negative and/or positive pressure, via a pressure device.

According to some embodiments, the common inlet port is in fluid communication with one edge of the primary channel, while the individual inlet ports are in fluid communication with the other edge of their associated primary channel.

According to some embodiments of the invention a new method is provided, comprising method steps of:
providing a device comprising plurality of Stationary Nanoliter Droplet Array (SNDA) components; each SNDA component comprising: at least one primary channel, at least one secondary channel, and a plurality of nano-wells that are each open to the primary channel and are each connected via one or more vents to the secondary channel, the vents are configured to enable passage of gas solely from the nano-wells to the secondary channel, such that when a fluid is introduced into the primary channel it fills the nano-wells, and the originally accommodated gas is evacuated via the vents and the secondary channel/s; a common inlet port, and optionally a distribution channel, configured to enable a simultaneous introduction of the fluid into all the primary channels of the different SNDA components; plurality of individual inlet ports, configured to enable individual introduction of fluid, each into a different primary channel of a different SNDA component; and at least one outlet port, and optionally an evacuation channel, configured to enable a simultaneous evacuation of the gas out of all the secondary channels;
loading the nano-wells of at least one of the SDNA components, with at least one first fluid, via the individual inlet ports and their associated primary channel/s;
loading the nano-wells of all the SNDA components, with a second fluid, via the common inlet port and the primary channels; and
examining the nano-wells' fluid droplets, formed by the second fluid and optionally formed together with the first fluid, according to the first fluid loading.

According to some embodiments, each of the loaded individual inlet ports is loaded with a different first fluid.

According to some embodiments, the loading of the nano-wells of all the SNDA components with the second fluid is simultaneous.

According to some embodiments, the method further comprising, during the loading step/s of the first fluid and/or the second fluid, applying negative pressure to at least one of the secondary channels, via the outlet port/s, configured to enable gas evacuation out of the nano-wells, via the vents and the secondary channel/s.

According to some embodiments, the method further comprising, after at least one of the loading steps, temporarily applying pressure to at least one of the primary channels, configured evacuate excessive fluid that has remained in the primary channel/s after filing the nano-wells.

According to some embodiments, a positive pressure is applied via:
the common inlet port, such that the excessive fluid in the primary channels is evacuated via the individual inlet port/s; or,
at least one of the individual inlet ports, such that the excessive fluid in the associated primary channel/s is evacuated via the common inlet port.

According to some embodiments, a negative pressure is applied via:
the common inlet port, such that the excessive fluid in the primary channels is evacuated via the common inlet port; or,
at least one of the individual inlet ports, such that the excessive fluid in the associated primary channel/s is evacuated via those individual inlet port/s.

According to some embodiments, the method further comprising treating the nano-wells' first fluid droplets, before the loading of the second fluid.

According to some embodiments, the step of treating comprising lyophilizing the nano-well's first fluid droplets.

According to some embodiments, the method further comprising treating the nano-wells' droplets formed by the first- and second-fluids.

According to some embodiments, the step of examining is provided via an imaging device and at least one computing processor.

According to some embodiments, step of examining, is configured to determine the effect of the first fluid on the second fluid.

There is provided, according to some embodiments of the present invention, a method including: providing a multiplexed stationary nanoliter droplet array (SNDA) device array, wherein the multiplexed SNDA device array may include one or more of SNDA devices, each SNDA device of the one or more SNDA devices may include a primary channel and a plurality of nano-wells that may each be open to the primary channel, each nano-well of the plurality of nano-wells may be connected by one or more vents to a secondary channel to enable passage of air from that nano-well to the secondary channel, each secondary channel may be connected to an evacuation channel, each of the primary channels may be connected to a separate inlet unique to that primary channel and to a common inlet that may be common to all of the primary channels of the multiplexed SNDA device array; and applying negative pressure at the evacuation channel to facilitate flow of one or more type of fluids that are placed in the one or more separate inlets to the corresponding primary channel and to the plurality of nano-wells that are open to the corresponding primary channel.

In some embodiments of the invention, the method may include: draining excess fluid of the one or more type of fluids from the primary channels after filling of the nano-wells.

In some embodiments of the invention, the method may include: draining excess fluid of the one or more type of fluids from the primary channels after filling of the nano-wells by applying negative pressure to each of the primary channels from the associated separate inlet.

In some embodiments of the invention, the method may include: draining excess fluid of the one or more type of fluids from the primary channels after filling of the nano-wells by applying positive pressure to the common inlet.

In some embodiments of the invention, the method may include: lyophilizing the one or more types of fluid in the nano-wells.

In some embodiments of the invention, the method may include: applying negative pressure at the evacuation channel to facilitate flow of a second fluid that is placed in the common or shared inlet to the primary channels. In some embodiments of the invention, the evacuation channel may include an opening, and the negative pressure may be applied at the opening of the evacuation channel.

In some embodiments of the invention, the method may include: examining the nano-wells to determine the effect of the one or more types of fluid on the second fluid.

In some embodiments of the invention, the one or more types of fluid includes one or more types of antibiotics and the second fluid includes a bacterial suspension.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A schematically illustrates an example of a plurality of stationary nanoliter droplet array (SNDA) components arranged in an array configuration, forming a rectangular multiplexed SNDA device, according to some embodiments of the invention;

FIG. 1B schematically illustrates another example of a rectangular multiplexed SNDA device, according to some embodiments of the invention;

FIG. 1C schematically illustrates yet another example of a plurality of SNDA components arranged in an array configuration, forming a rectangular multiplexed SNDA device, according to some embodiments of the invention;

FIG. 1D and 1E schematically illustrate examples of two configuration arrangement for the SNDA nano-wells, according to some embodiments of the invention;

FIGS. 1F and 1G schematically demonstrate more views, closer and 3D oriented, of the nano-well configuration, as in FIG. 1E, according to some embodiments of the invention;

FIG. 2 schematically illustrates an arrangement of distribution channels of a portion of a multiplexed array of SNDA devices, according to some embodiments of the invention;

FIG. 3 schematically illustrates distribution channels a multiplexed array of SNDA devices, the lengths of the channels being adjusted and configured to enable a uniform flow rate, according to some embodiments of the invention;

FIG. 4A schematically illustrates an example of channels of a system of multiple multiplexed SNDA devices, where all SNDA devices are oriented parallel to one another, according to some embodiments of the invention;

FIG. 4B schematically illustrates an example of channels of a system of multiple multiplexed SNDA devices, where some SNDA devices are oriented perpendicularly to others, according to some embodiments of the invention;

FIGS. 5A and 5B schematically illustrate examples of plurality of stationary nanoliter droplet array (SNDA) components (six SNDA components, in this example), arranged in a star configuration, forming a round multiplexed SNDA device, according to some embodiments of the invention;

FIG. 6 schematically demonstrates a flowchart of a method for loading and using a multiplexed SNDA device, according to some embodiments of the invention;

FIG. 7A depicts the different types of fluids that are loaded into the SNDA components, via their individual inlets, according to some embodiments of the invention;

FIG. 7B depicts the loading of a second fluid via common the inlet, according to some embodiments of the invention; and

FIG. 8 demonstrates trapped droplets of fluid is the SNDA nano-wells, after main channel evacuation/shearing, in an image taken during the application of some of the device's operation method steps, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

According to some embodiments of the invention, a new device is provided comprising:
plurality of Stationary Nanoliter Droplet Array (SNDA) components; each SNDA component comprising: at least one primary channel; at least one secondary channel; and a plurality of nano-wells that are each open to the primary channel and are each connected by one or more vents to the secondary channel; the vents are configured to enable passage of gas solely (e.g. air) from the nano-wells to the secondary channel, such that when a fluid (e.g. liquid) is introduced into the primary channel it fills the nano-wells, and the originally accommodated gas (e.g. air) is evacuated via the vents and the secondary channel/s;
a common inlet port, and optionally a distribution channel, configured to enable a simultaneous introduction of the fluid (e.g. liquid) into all the primary channels;
plurality of individual inlet ports, configured to enable individual introduction of fluid (e.g. liquid), each into a different primary channel; and
at least outlet port, and optionally an evacuation channel, configured to enable a simultaneous evacuation of the gas out of all the secondary channels.

According to some embodiments, the common inlet port is in fluid communication with one edge of the primary channel, while the individual inlet ports are in fluid communication with the other edge of the primary channel.

According to some embodiments, the plurality of the SNDA components are aligned parallel to one another and laterally displaced relative to one another, such that the device comprises a rectangular form.

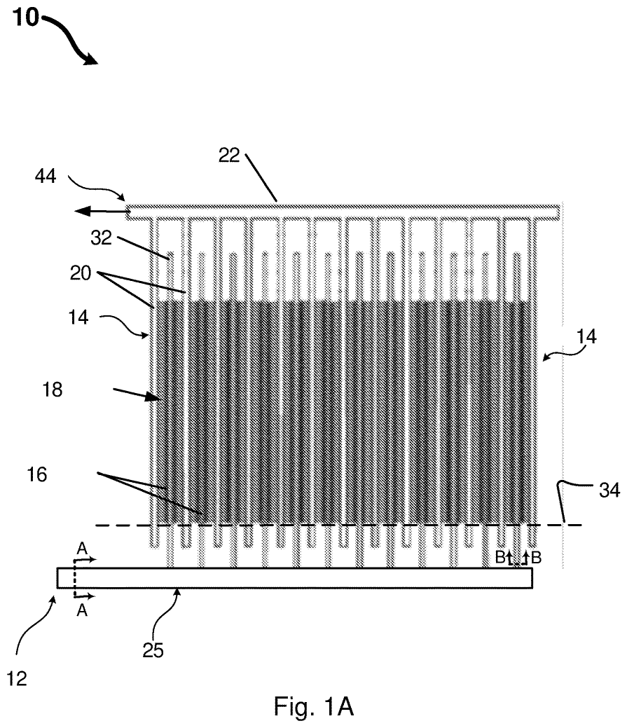

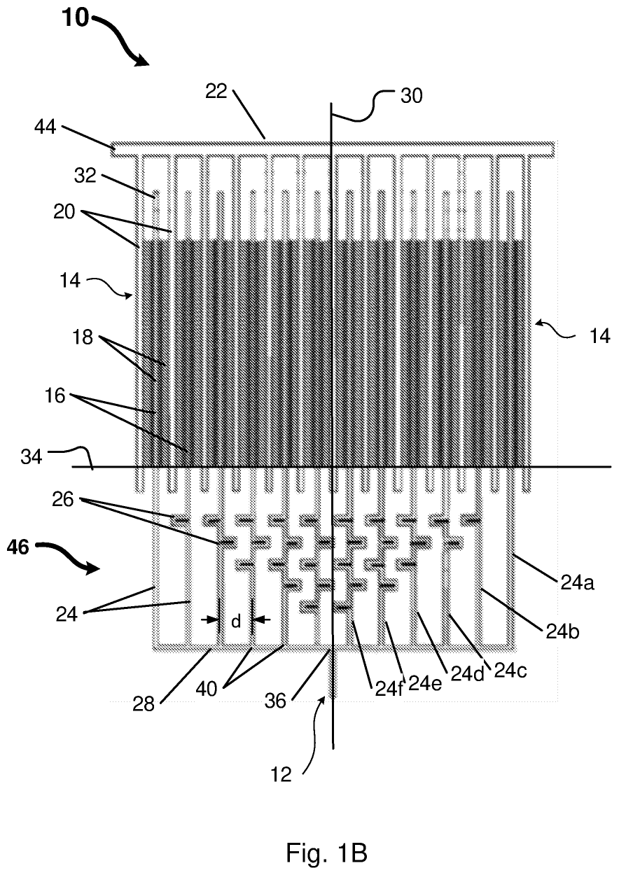

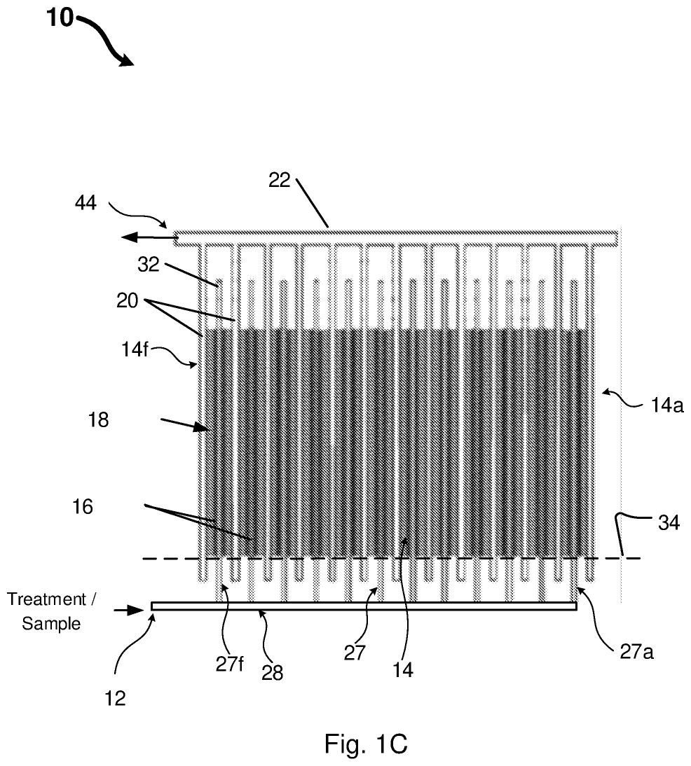

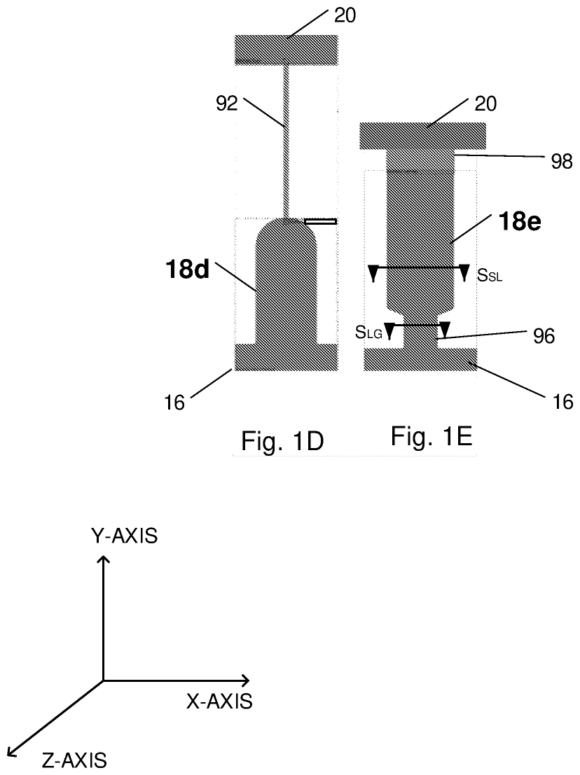

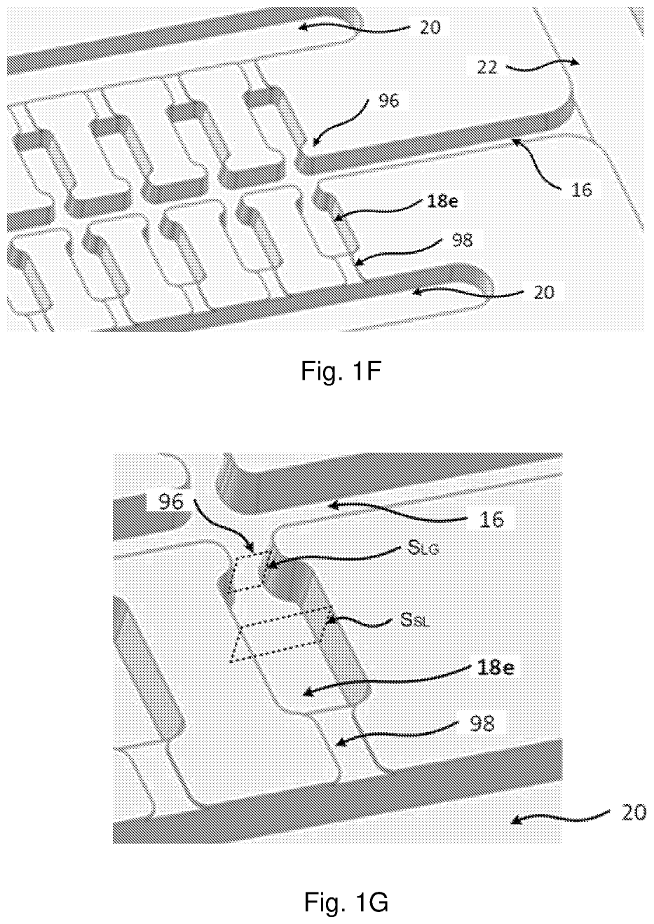

In accordance with some embodiments of the invention, and as demonstrated in FIGS. 1A, 1B and 1C, plurality of stationary nanoliter droplet array (SNDA) components 14 (twelve SNDA components, in these examples) are arranged in an array configuration, forming a rectangular multiplexed SNDA device 10. In the multiplexed SNDA device 10, a fluid (e.g. liquid) can be introduced into the nano-wells 18 of all of the SNDA components 14 of the SNDA device 10, via a common inlet opening 12, also referred to herein as a shared inlet.

According to some embodiments, and as demonstrated in FIG. 1B, from the common inlet opening 12, the introduced fluid (e.g. liquid) flows through an arrangement of distribution channels 46 that connects the inlet opening to the primary channel 16 of each SNDA component 14. As the fluid flows along the primary channel of each SNDA component, the fluid fills the nano-wells 18 along that primary channel.

According to some embodiments, in the multiplexed SNDA device 10, a plurality of SNDA components 14 are arranged substantially parallel to one another and are substantially aligned with one another. In this parallel and aligned configuration, the primary channels 16 of the SNDA components 14 are parallel to one another and are laterally displaced relative to one another. Thus, in this configuration, the connections of all of the primary channels to distribution channel/s lie along a single line 34, e.g., a line that is perpendicular to the orientation of the primary channels.

According to some embodiments, as the fluid (e.g. liquid) fills the nano-wells 18 of each SNDA component 14, gas (e.g. air) escapes via vent/s (92 in FIG. 1D and 98 in FIGS. 1E-1G) of each nano-well 18 into a secondary channel/s 20. According to some embodiments, each SNDA component 14 typically includes two secondary channels 20, configured such that gas (e.g. air) from the nano-wells on either side of the primary channel 16 is enabled to vent out of the nano-well 18. According to some embodiments, in the multiplexed SNDA device 10, all of the secondary channels are arranged to connect to a single common evacuation channel 22. According to some embodiments, concurrently with introduction of fluid (e.g. liquid), via the common inlet opening 12, negative pressure can be applied to the evacuation channel 22, via an outlet 44, configured to facilitate removal of the gas (e.g. air) from the nano-wells, and to facilitate flow of the introduced fluid (e.g. liquid) into the nano-wells.

According to some embodiments, and as demonstrated at least in FIG. 1A two adjacent SNDA components 14 can share a common secondary channel 20, where their primary channels reside on different sides of the secondary channel. According to some embodiments, most secondary channels 20 are being connected (via the vents) to—or shared by—two different SNDA components 14, except for the ones that are located at the edges of the multiplexed SNDA device 10.

According to some embodiments, the distribution channels are configured such that a fluid (e.g. liquid) that is introduced via the common inlet opening 12 flows into each primary channel 16 of the SNDA components 14 of the multiplexed SNDA device 10, at substantially equal flow rates. For example, flow rates may be considered to be substantially equal, when the differences in flow rate between two distribution channels does not exceed 5%, or, in some cases, does not exceed 3%. In this manner, the nano-wells of all of the SNDA components 14, in the multiplexed SNDA device 10, fill concurrently and at a common flow rate.

According to some embodiments, and as specifically demonstrated in FIG. 1A, some SNDA components 14, of the multiplexed SNDA device 10, are closer to the common inlet opening 12 than others. Therefore, according to some embodiments, a wide distribution channel 25 is provided, as a connecting channel between the single inlet 12 and the primary channels 16, feeding the wells 18 of the SNDA components 14. Accordingly, the cross-section of the wide distribution channel 25 is selected to be larger than the cross-section of the primary channels, such that the wide distribution channel 25 is configured to be filled with fluid (e.g. liquid), to a predetermined level of its volume, before the fluid pressure that is formed there-within enables the fluid to flow and enter into the primary channel/s 16. According to some embodiments, the cross-section of the distribution channel 25 and/or the primary channel/s comprises a form selected from: a circle, an oval, a rectangle, a square, any polygon and any combination thereof.

According to some embodiments, the cross-section of the distribution channel 25 and the primary channel/s comprises a circular form. Accordingly the diameter D_{DCh} of the wide distribution channel 25 is selected to be larger than the diameter D_{PCh} of the primary channel/s 16 (D_{DCh}>D_{PCh}), such that the wide distribution channel 25 is configured to be filled with fluid (e.g. liquid) to a predetermined threshold (for a non-limiting example about 95%-99%) of its volume, before the fluid pressure that is formed there-within enables to fluid to enter into the primary channel/s 16, in other words, before the fluid pressure that is formed there-within raises high enough, to enable the fluid to flow against the primary channel/s flow resistance.

According to some related embodiments, where their cross section is circular, an important solution to the Navier-Stokes equations is the Poiseuille (or Hagen-Poiseuille) flow, which applies when a pressure gradient is used to drive a liquid through a capillary or channel. For a capillary with cylindrical cross-section the following expression for the volume flow, Q, exists:

$$Q = \frac{Δ V}{t} = \frac{π {R}^{4} V}{8 η L} Δ P \qquad Eq . \{ 1 \}$$

where R is the radius of the capillary, L is its length and ΔP is the pressure drop across this length (also called hydraulic pressure). The term, 8ηL/πR⁴, of which the reciprocal appears in Eq. {1}, is also called the fluidic resistance. The dependency on 1/R⁴ implies that the fluidic resistance increases drastically as the channel dimensions are reduced. Consequently, higher pressure drops are necessary to move fluid (e.g. liquid) through smaller conduits. For channels with noncylindrical cross sections, expressions similar to those in Eq. {1} can be found, but with different terms for the fluidic resistance.

According to some related embodiments, where their cross section is circular, the ratio between D_{DCh}:D_{PCh} is respectively selected from: 10:1, 9:1, 8:1, 7:1, 6:1, 5:1 and any combination thereof. According to some embodiments, the ratio between D_{DCh}:D_{PCh} is respectively 4 or more : 1. According to some embodiments, the ratio between D_{DCh}:D_{PCh} is respectively selected X:1 where X is selected between: 10>X>4.

According to some embodiments, the cross-section of the distribution channel 25 and the primary channel/s comprises a rectangular form. For this example, shown in FIG. 1A, AA is the cross section of the wide distribution channel, where h_{DCh} is the smaller side and w_{DCh} is the other side of the AA rectangular cross section and BB is the cross section of the primary channel, where h_{PCh} is the smaller side and w_{PCh} is the other side of the BB rectangular cross section. According to such embodiments, the wall dimension h_{DCh} of the wide distribution channel 25 is selected to be larger than the wall dimension h_{PCh} of the primary channel/s 16 (h_{DCh}>h_{PCh}), such that the wide distribution channel 25 is configured to be filled with fluid (e.g. liquid) to a predetermined threshold (for a non-limiting example about 95%-99%) of its volume, before the fluid pressure that is formed there-within enables to fluid to enter into the primary channel/s 16, in other words, before the fluid pressure that is formed there-within raises high enough, to enable the fluid to flow against the primary channel/s resistance. According to a non-limiting example: AA=W_{DCh}×h_{DCh}=0.3 mm×0.3 mm and BB=w_{PCh}×h_{PCh}=0.15 mm×0.1 mm.

According to some related embodiments, where their cross section is rectangular, an important solution to the Navier-Stokes equations is the Poiseuille (or Hagen-Poiseuille) flow, which applies when a pressure gradient is used to drive a fluid (e.g. liquid) through a capillary or channel. For a capillary with rectangular cross-section the following expression approximation for the volume flow, Q, exists:

$$Q = \frac{Δ V}{t} = \frac{{h}^{4}}{12 η La} Δ P ( 1 - 0.63 a ) \qquad Eq . \{ 2 \}$$

where h is the smaller wall, and w is the other wall of the capillary, L is its length, a=h/w is the aspect ratio of capillary walls, and ΔP is the pressure drop across this length (also called hydraulic pressure). The term, 12ηLa/h⁴, of which the reciprocal appears in Eq. {2}, is also called the fluidic resistance. The dependency on 1/h⁴ implies that the fluidic resistance increases drastically as the channel dimensions are reduced. Consequently, higher pressure drops are necessary to move fluid (e.g. liquid) through smaller conduits.

According to some related embodiments, where their cross section is rectangular, the ratio between h_{DCh}:h_{PCh} is respectively selected from: 10:1, 9:1, 8:1, 7:1, 6:1, 5:1 and any combination thereof. According to some embodiments, the ratio between h_{DCh}:h_{PCh} is respectively 4 or more: 1. According to some embodiments, the ratio between h_{DCh}:h_{PCh} is respectively selected X.1 where X is selected between: 10>X>4.

According to some embodiments, and as demonstrated in FIG. 1B, 1C, 2, 3, 4A and 4B, some SNDA components 14 of the multiplexed SNDA device 10 are near/closer to the common inlet opening 12 than others. Therefore, a distribution channel 24f, 27f that connects the common inlet opening 12 to a closer SNDA component is configured to resist, or introduce a delay, into the flow through that distribution channel, relative to a distribution channel 24a, 27a that connect a more distant SNDA component to the common inlet opening.

According to some embodiments, and as demonstrated in FIG. 1B, the distribution channel/s 24 that connect the common inlet opening 12 with the SNDA components that are closer to the inlet opening are configured to be lengthened by an addition of bends or open loops 24b, 24c, 24d, 24e, 24f. In this manner, the lengths of all distribution channels 24a, 24b, 24c, 24d, 24e, 24f that connect each SNDA component to the common inlet opening are equal. For example, where the flow through the distribution channels is assumed to be laminar, and where all of the distribution channels have substantially identical cross sections, the resistance to flow is assumed to be simply proportional to the length of the channel. In this case, where the flow rate is assumed to be equal to the pressure difference divided by the resistance to flow (analogous to Ohm's law for electrical current, potential difference, and electrical resistance, respectively), a calculation of the required additional length that is to be added to each distribution channel to ensure identical flow rates may be similar to analogous calculations for simple electrical circuits based on Kirchhoff's rules for electrical circuits.

According to some embodiments, alternatively or in addition, the cross-sectional area of a shorter distribution channel, e.g., that connects the common inlet opening to a closer SNDA device is configured with a narrower diameter than a longer distribution channels that connects the common inlet opening to a more distant SNDA component.

According to some embodiments, and as specifically demonstrated in FIG. 1C, a flow resistance to the fluid (e.g. liquid) entering from common inlet 12 via a common distribution channel 28 is configured to be made significantly low at a distal distribution channels of a distal SNDA component 14a (for example 27a is distal from inlet 12), compared with a proximal distribution channels of a proximal SNDA component 14f (for example 27f is proximal to inlet 12), such that flow rate entering to each of the primary channels is about equal. According to some embodiments, a reduced cross-sectional area is configured to reduce a flow rate, through a proximal distribution channel, relative to the flow rate through a distal distribution channel. In this way, the fluid (e.g. liquid) that flows through the distribution channels 27 from the common inlet opening 12, via the common distribution channel 28, reaches all of the SNDA components 14 concurrently.

In some related embodiments, the connecting channels are designed differently one from another (by length, as in 24 FIG. 1B, or by width, as in 27 FIG. 1C) and/or that the resistance at the common distribution channel (as in 25 FIG. 1A) is configured to be reduced, such that fluid (e.g. liquid) can first fill the common distribution channel 25,28 and then flow through the SNDAs' main channels to enable simultaneous loading of the SNDA components.

According to some embodiments, in addition to the introduction of a fluid (e.g. liquid) into all of the SNDA components 14 of the multiplexed SNDA device 10, via the common inlet opening 12, the primary channel of each SNDA device can include an individual opening 32, configured to enable selective introduction of a fluid (e.g. liquid) into selected individual SNDA component 14. Typically (but not necessarily), the individual opening of each primary channel is located at an end of the primary channel that is opposite the opening of the primary channel to the distribution channels. For example, different experiments can be conducted concurrently, by introducing different antibiotic solutions, or that reagent solutions can be introduced into different SNDA component. According to some embodiments, no antibiotic or reagent solutions should be introduced into an SNDA component that is to function as a control measure.

According to some embodiments, the multiplexed SNDA device 10 comprises a flat rectangular form, such that all SNDA components 14 are arranged in an array configuration and are oriented parallel to one another and linearly displaced relative to one another along a single pair of orthogonal axes. This rectangular arrangement within the multiplexed SNDA device 10 can be advantageous over other arrangements of SNDA devices (e.g., a circular arrangement, where SNDA devices extend radially from an inlet opening). For example, the rectangular arrangement is configured to enable more efficient use of space/volume, e.g., more compact filling, than an arrangement where adjacent SNDA components are rotated relative to one another. The rectangular arrangement is configured to enable efficient and easy control of the SNDA components, for example when positioning (whether manually or by an automatically controlled stage) a successive SNDA component within a field of view of a viewing or imaging device.

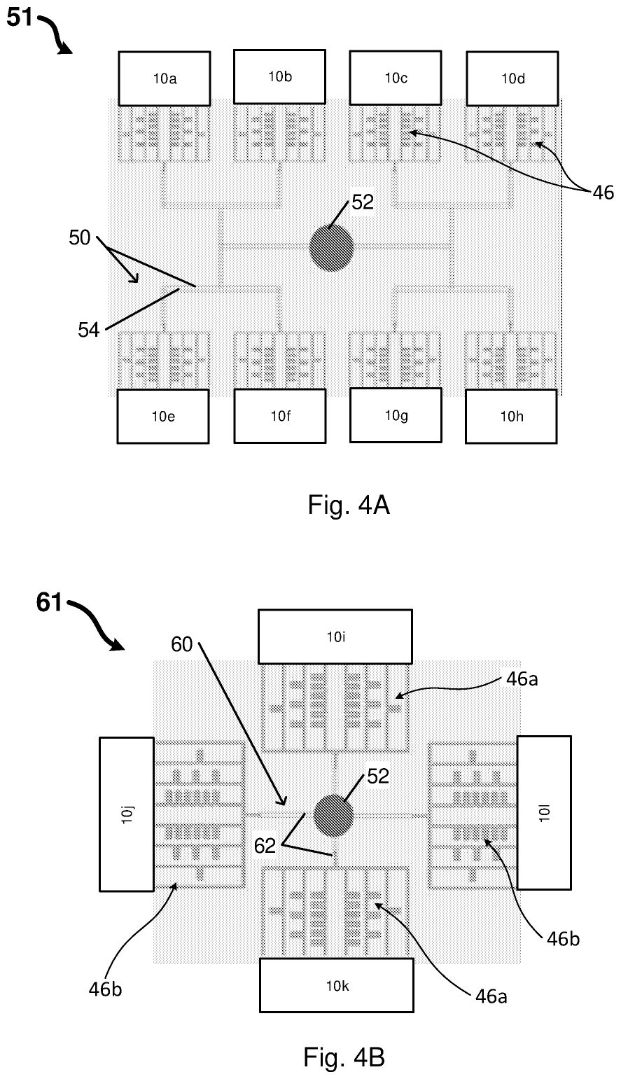

According to some embodiments, a plurality of rectangular multiplexed SNDA devices 10 are configured to be connected to a common inlet, as demonstrated in FIGS. 4A and 4B. For example, as in FIG. 4A, the plurality of rectangular multiplexed SNDA devices 10a-10h can be connected to the common inlet 52 in a symmetric manner such that the lengths of channels that connect the common inlet to the inlet opening of each of the multiplexed SNDA device 10a-10h are equal to one another. In some cases, as in FIG. 4B, one or more of the multiplexed SNDA devices 10i-10l can be rotated 90° relative to other of the multiplexed SNDA device. When one multiplexed SNDA device is rotated by 90° relative to another, the aforementioned advantages of efficient use of space and ease of control may still be present.

Reference is made again to FIG. 1B, which schematically illustrates an example of a rectangular multiplexed device 10 of stationary nanoliter droplet array (SNDA) components 14, according to some embodiments of the invention.

In some embodiments, the multiplexed SNDA device 10 is provided with a plurality of SNDA components 14, which are arranged parallel to one another. A fluid (e.g. liquid) may be introduced concurrently into all SNDA components 14 via common inlet 12, also referred to herein as shared inlet 12. For example, common inlet 12 may connect to an opening in a cover (not shown) that covers multiplexed SNDA device 10.

According to some embodiments, the common inlet 12 is connected to each of the SNDA components 14 via a distribution channel 24. In the example shown, distribution channels 24 branch off of a single distribution trunk channel 28. According to some embodiments, and as in the shown example, distribution channels 24 branch off perpendicularly from distribution trunk channel 28. In other examples/embodiments, distribution channels 24 can otherwise connect to common inlet 12. For example, a distribution channel 24 can connect to common inlet 12 via a diagonal or curved segment of that distribution channel 24, can branch off of distribution trunk channel 28 at an oblique angle, or may otherwise connect to common inlet 12.

According to some embodiments, and as in the shown example, common inlet 12 is located at symmetry axis 30, and distribution channels 24 are arranged symmetrically about symmetry axis 30. In other examples/embodiments, common inlet 12 can be located closer to one lateral side of multiplexed SNDA devices 10, e.g., such that a distance between common inlet 12 and an SNDA component 14 at one end of multiplexed SNDA device 10 is less than the distance between common inlet 12 and an SNDA component 14 at the other end of the multiplexed SNDA device 10.

According to some embodiments, each SNDA component 14 comprises a primary channel 16 that connects to one of distribution channels 24. Thus, a fluid (e.g. liquid) that is introduced into common inlet 12 can flow from common inlet 12 and into primary channels 16 of all SNDA components 14 of multiplexed SNDA device 10 via distribution channels 24 that connect common inlet 12 to all primary channels 16.

According to some embodiments, a separate inlet 32 (located at an opening in a cover of multiplexed SNDA device 10) to each primary channel 16 can be located at an end of primary channel 16 that is opposite to an end that is connected via distribution channel 24 to common inlet 12. Accordingly, fluid (e.g. liquid) can be introduced into primary channel 16 of a selected SNDA components 14 of the multiplexed SNDA device 10, via separate inlets 32 of the selected SNDA components 14, without being introduced into other SNDA components 14 of the multiplexed SNDA device 10.

According to some embodiments, a fluid (e.g. liquid) that flows into a primary channel 16 of an SNDA component 14 can flow into nano-wells 18 that are open to that primary channel 16. As each nano-well 18 is filled, any air or gas that had previously filled that nano-well 18 is enabled to flow outward via one or more vents of that nano-well 18 (not visible at the scale of FIG. 1B) to a secondary channel 20 that is adjacent to that nano-well 18. For example, a typical SNDA component 14 includes two secondary channels 20, on opposite sides of its primary channel 16.

In some embodiments, each nano-well 18 has a volume that is less than 100 nanoliters. In some embodiments, each vent has a length of a few micro-meters (less than or about 10 μm). In some embodiments, each nano-well 18 has a length about 400 μm (y-axis), a width of about 200 μm (x-axis), and a height of about 100 μm (z-axis), each vent has a width of about 7 μm and a height of about 100 μm, each primary channel 16 (and, possibly, each distribution channel 24) has a width of about 150 μm, and each secondary channel 20 has a width of about 1 mm. In other examples, structure of a multiplexed SNDA device 10 can have different dimensions.

FIGS. 1D and 1E schematically illustrate examples for nano-well arrangements 18d and 18e, according to some embodiments of the invention. Nano-wells 18d and 18e may both be about 200 μm by width (x-axis), about 400 μm by length (y-axis) and thickness of about 100 μm (z-axis).

FIG. 1D demonstrates an example for a nano-well arrangement 18d, which is connected to the secondary channel via a long and narrow pipe-like vent 92. According to some embodiments, the pipe-like vent 92 comprises a width along an x-axis of about 7 μm, a length along a y-axis of about 500 μm and a height along a z-axis of about 7 μm.

FIG. 1E demonstrates a nano-well arrangement 18e, which is connected to the secondary channel 20 via a short and wide window-like vent 98, configured for better gas evacuation and more efficient production/manufacture methods. According to some embodiments the window-like vent 98 comprises, a width along an x-axis of about 200 μm, a length along a y-axis of about 100 μm and a height along a z-axis of about 7 μm. According to some embodiments, the window-like vent 98 is located at the upper or bottom side (z-axis) of the nano-well, for easier manufacturing.

According to some embodiments, FIG. 1E further demonstrates nano-well arrangement 18e comprising a neck configuration 96 at the end, which is open towards the primary channel 16, according to some embodiments of the invention. According to some embodiments, the nano-well's neck opening 96 to the primary channel 16 is characterized in that the ratio between the area of the opening (S_{LG}) and the surface area of the nano-well's walls (S_{SL}) is configured to reduce an energy barrier for a droplet shearing, such that a sheared fluid (e.g. liquid) is retained as a droplet within said nano-well. Other designs and sizes of nano-wells 18 may be used.

According to some embodiments, the ratio S_{LG}/S_{SL} is selected between about 0.4 and about 1.0 (0.4≤S_{LG}/S_{SL}<1.0).

FIGS. 1F and 1G schematically demonstrate more views, closer and 3D oriented, for the nano-well configuration 18e, as disclosed in FIG. 1E.

In the examples shown in FIGS. 1A-1C, all secondary channels 20 of multiplexed SNDA device 10 connect to a single evacuation channel 22. In this manner, gas (e.g. air) from all nano-wells 18 can be evacuated via a single opening 44. According to some embodiments, negative pressure that is applied to evacuation channel 22 is, therefore, applied to all secondary channels 20 and to all nano-wells 18. Thus, application of negative pressure to evacuation channel 22 facilitates flow of liquid into nano-wells 18.

According to some embodiments of the invention, a method is provided for using the multiplexed SNDA device 10, according to any one of the above-mentioned embodiments. The method comprises loading SNDA components 14 in a two-phase process. In a first loading phase, a first fluid (e.g. liquid) or set of fluids, e.g., antibiotics or another examined fluid/liquid can be introduced into nano-wells 18. In a second loading phase, a sample, e.g., a bacterial suspension, can be loaded into nano-wells 18. Thus, the reaction between the first fluid and the sample can be examined, for example, to determine the effect of an antibiotic on a bacteria.

For example, the first fluid (e.g. liquid) can be introduced into primary channel 16 of a selected SNDA component/s 14 of multiplexed SNDA device 10, via individual inlet/s 32 of the selected SNDA component/s 14, without being introduced into other SNDA component/s 14 of multiplexed SNDA device 10. Thus, different types of fluids, e.g., different types of antibiotics, can be introduced into different primary channels 16 of selected SNDA components 14. The fluid (e.g. liquid) can be introduced into the primary channel 16 of the selected SNDA components by placing the fluid in the individual inlet 32 of a primary channel 16.

According to some embodiments, the method further comprises applying suction or negative pressure to the secondary channels. According to some embodiments, after placing the examined fluids in the individual inlets 32 and/or after loading the sample via the common inlet 12, and filling the nano-wells 18, a temporary application of suction or negative pressure, can be applied via outlet 44 and the evacuation channel 22. The suction or negative pressure can affect all secondary channels 20 and all nano-wells 18, by generating vacuum forces that can force gas (e.g. air) out thereof via the vents (92 FIG. 1D, 98 FIGS. 1E-1G) and introduced fluid (e.g. liquid) into nano-wells 18. Thus, application of suction to evacuation channel 22 facilitates flow of fluid (e.g. liquid) into nano-wells 18. According to some embodiments, the step of applying negative pressure to the secondary channels can be applied to each one of the loading steps, the first fluid loading and/or the sample fluid loading.

According to some embodiments, the negative pressure is applied in a controllable manner, for example by connecting a syringe pump or other controllable vacuum source or suction device to evacuation channel 22. Thus, activating suction at a single opening 44 and via the evacuation channel 22 forces different types of fluids (e.g. liquids) into nano-wells 18 of selected SNDA components 14 of the multiplexed SNDA device.

In some embodiments, the method further comprises a step of removing, draining and/or shearing excess fluid (e.g. liquid) from primary channel 16, after filling the nano-wells 18, at least after the step of filling the 1^{st} fluid/s and before the step of loading the sample to be examined and optionally after the step of sample loading as well.

According to some embodiments, negative pressure or suction can be applied to the primary channels 16, preferably via the individual inlets 32 (however, also possible via common inlet 12 and the optional common distribution channel 25) to draw excess fluid (e.g. liquid) that has remined in the primary channels 16, after filling all of the nano-wells 18, while maintaining the nano-wells' formed droplets (e.g. liquid) there within.

According to some embodiments additionally or alternatively, positive pressure can be applied to the primary channels 16, preferably via the common inlet 12 and the optional common distribution channel 25 (however, also possible via the individual inlets 32) to push/shear fluid (e.g. liquid) that has remained in the primary channel, after filling all the nano-wells, out of the primary channels, optionally all at once, while maintaining the nano-wells' formed droplets (e.g. liquid) there within.

In some embodiments the method further comprising a step of lyophilizing or otherwise treating the first loaded fluid, e.g., to retain the antibiotic in nano-wells 18. At this stage, multiplexed SNDA device 10 may be ready for use.

According to some embodiments, the Nano-wells 18 can then be examined to determine the effect of the antibiotic/s on the bacteria. For example, an image of the SNDA device can be analyzed, either by eye or by an imaging device and an analyzing processor, to determine the effect of the antibiotic/s on the bacteria.

According to some embodiments, the structure of multiplexed SNDA device 10, including channels (e.g., common inlet 12, distribution trunk channel 28, distribution channels 24, primary channels 16, separate inlets 32, secondary channels 20, evacuation channel 22, and other channels) and nano-wells 18, can be formed together with a base that forms the bottom of each of the structures. For example, the base and structure can be formed using any applicable method, for example, by a molding, spin coating, stamping process, hot embossing, three-dimensional (3D) printing, etc., or can be formed by applying an etching, micromachining, or photolithography process to a block of material. According to some embodiments a cover can then be attached to the base and structure to cover the structure. According to some embodiments, the cover is transparent to enable optical or visual examination of the contents. Typically, the cover includes openings to enable introduction of liquids into the structure. For example, one or more openings can be positioned so as to enable introduction of liquids into common inlet 12, and, at least in some cases, into one or more separate inlets 32. One or more openings 44 can be positioned to enable evacuation of air there-through, or application of negative pressure to evacuation channel 22.

According to some embodiments, the length (or, in some cases, the cross-sectional area, or both) of each distribution channel 24 is selected such that the rate of the flow of a fluid (e.g. liquid) that is introduced into that distribution channel 24, via common inlet 12, is substantially equal to the rate of flow in all of the other distribution channels 24. In the example shown, in order to achieve the equal flow rates, the lengths of each of distribution channels 24b to 24f is increased by the addition of one or more extensions, such as open loops 26. In the example shown, all open loops 26 are of substantially equal, having predetermined length, and are approximately U-shaped (e.g., with a curved or flat bottom). In the schematic example shown, the length of each open loop 26 is equal to separation distance d between two adjacent connection nodes 40, where adjacent distribution channels 24 connect to distribution trunk channel 28. The number of open loops 26 added to each distribution channel 24 is selected to retard the rate of flow in a distribution channel 24 (e.g., in distribution channel 24f) that connects common inlet 12 to a more proximal (e.g., to common inlet 12 or to inlet connection 36) SNDA component 14 to equal the rate of flow in a distribution channel 24 (e.g., distribution channel 24a) that connects common inlet 12 to a more distal SNDA component 14.

It may be noted that, in the schematic example shown, the number of open loops 26 that are added to each distribution channel 24 is based on a simple calculation, in which the number of open loops 26 of length d that are added to each distribution channel 24b to 24f that branches off of distribution trunk channel 28, at a connection node 40, is equal to the distance between that connection node 40 and the most distal node (e.g., the connection node 40, where distribution channel 24a connects to distribution trunk channel 28). A more accurate calculation that takes into account different flow rates through different sections of distribution trunk channel 28 is described below.

In other examples, the lengths of different distribution channels 24 can be otherwise adjusted, cross sectional areas of different distribution channels 24 can be adjusted, surface properties of different distribution channels 24, or other adjustments to distribution channels 24 can be made to achieve equal rates of flow through all distribution channels 24.

According to some embodiments, when a pressure difference between common inlet 12 and evacuation channel 22 is constant (e.g., due to negative pressure that is applied to evacuation channel 22), the rate of flow in each distribution channel 24 of a fluid (e.g. liquid) that is introduced into multiplexed SNDA device 10, via common inlet 12, can be inversely proportional to the resistance of each distribution channel 24 to flow (e.g., analogous to Ohm's law that states that current is equal to potential difference divided by electrical resistance). In the case of laminar flow, resistance to flow can be a function of at least the viscosity of the fluid/liquid, cross sectional area of a conduit, and length of the conduit.

In the example shown, the cross-sectional areas of all distribution channels 24, as well as of distribution trunk channel 28, are substantially identical. Therefore, in the event of laminar flow of a single incompressible liquid through all distribution channels 24, the rate of flow through a distribution channel 24 can be adjusted by adjusting the length of that distribution channel 24. Furthermore, it may be assumed that the resistances to flow through all SNDA component 14 of multiplexed SNDA device 10 are substantially identical. Therefore, it may be assumed that, when substantially equal flow rates are achieved, the difference in pressure between inlet connection 36 between common inlet 12 and distribution trunk channel 28, and the connection (along SNDA device connection line 34) of each distribution channel 24 to its connected SNDA components 14 is the same for all distribution channels 24.

Accordingly, a calculation of a length of each distribution channel 24, or, equivalently, of a number of open loops 26 (of predetermined length) that are to be included in each distribution channel 24, can be based on an analogy to Kirchhoff' s rules for electrical circuits.

According to some embodiments, in such an analogous calculation, the pressure difference between two points that are connected by one or more conduits is analogous to a difference in electrical potential, or voltage. As in the electrical analog, the pressure difference is the same for all parallel conduits that connect the two points. The flow rate is analogous to electrical current. As in the electrical analog, at a node where a single conduit branches into two or more branch conduits, the total flow rate into the node (e.g., through the single node) is equal to the total flow rate out of the node (e.g., through all the branch conduits). Resistance to flow in each conduit is analogous to electrical resistance. Thus, as in Ohm's law of the electrical analog, the rate of flow in a conduit is equal to the pressure difference between the ends of the conduit divided by the resistance to flow in that conduit.

Therefore, as in the electrical analog, when conduits are connected in series, the total resistance to flow Rₛ is the sum of the resistances to flow of the connected conduits:

Rₛ=R₁+R₂+ . . . +Rₙ,

where R₁, R₂, . . . Rₙ are the resistances to flow of each of the connected conduits. Similarly, when n conduits are connected in parallel, the total resistance to flow Rₚ may be calculated from the formula:

1/Rₚ=1/R₁+1/R₂+ . . . +1/Rₙ.

In an example where laminar flow may be assumed (e.g., slow flow rates and low Reynold' s number), and where all of the conduits have similar walls and cross sections, the resistance to flow is substantially proportional to the length of the conduit. Therefore, in such a case, lengths of conduit sections may be substituted for the resistances in the above formulae.

Multiplexed SNDA device 10 is configured to enable substantially equal flow rates through all of distribution channels 24. In particular, calculations based on the analogy to electrical current can be applied to distribution trunk channel 28 and distribution channels 24 between inlet connection 36 and SNDA device connection line 34. The purpose of the calculation is to determine any additional resistance to flow that is to be added to distribution channels 24, in order to enable substantially equal flow rates in all distribution channels 24.

According to some embodiments, by making the flow rates equal in all distribution channels 24, all SNDA components 14 can be filled concurrently and the terms applied on SNDAs are identical. In the absence of a configuration that enables equal flow rates, an SNDA component 14 that is nearest to common inlet 12 (e.g., an SNDA component 14 that is connected to distribution channel 24f) would be likely to completely fill before an SNDA component 14 that is further from common inlet 12 (e.g., an SNDA component 14 that is connected to any of distribution channels 24a to 24e) has completed filling, or perhaps has not even begun to fill. Such uneven filling could adversely affect results of testing that entails comparison of results in different SNDA components 14 of multiplexed SNDA device 10.

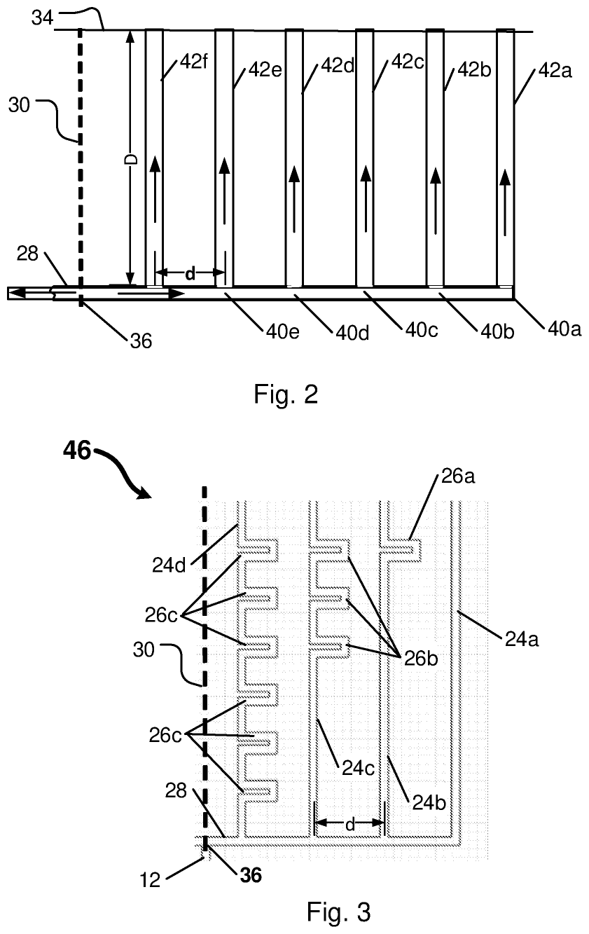

FIG. 2 schematically illustrates an arrangement of distribution channels of a portion of a multiplexed array of SNDA components, according to some embodiments of the invention.

As shown in FIG. 2, all unlengthened distribution channels 42a to 42f are shown without any loops. As shown, unlengthened distribution channels 42a to 42f are shown with their minimum lengths for connecting inlet connection 36 with SNDA components 14, prior to adjustment in order to provide a uniform flow rate in all of unlengthened distribution channels 42a to 42f. The length of each of unlengthened distribution channels 42a to 42f, e.g., from its connection to distribution trunk channel 28 at one of connection nodes 40a to 40f, to its connection to an SNDA component 14, at SNDA device connection line 34, is channel minimum length D. The lateral center-to-center distance between adjacent connection nodes 40a to 40f is separation distance d.

In this example, since the path between inlet connection 36 and SNDA device connection line 34, via unlengthened distribution channel 42a, is longer than the path via other unlengthened distribution channels 42b - 42f, any adjustments to the lengths of distribution channels 24a to 24f may require lengthening of unlengthened distribution channels 42b to 42f, rather than shortening unlengthened distribution channel 42a. In other examples/embodiments, e.g., where diagonal or other variants of distribution channels are allowed, adjustment can include shortening distribution channels.

According to some embodiments, the calculation yields a total channel length L, for each of distribution channels 24a to 24f, that enables a uniform flow rate through all of the distribution channels 24a-24f. As stated above, in the current example, total length Lₐ of distribution channel 24a between connection node 40a and SNDA device connection line 34 is equal to minimum length D.

According to some embodiments, at connection node 40b, in order that the flow rate via distribution channel 24b between connection node 40b and SNDA device connection line 34 equal that via distribution channel 24a, the resistances to flow via distribution channels 24a and 24b, and thus total lengths Lₐ and L_{b}, respectively, are to be made equal. The length of a path between connection node 40b and SNDA device connection line 34 via unlengthened distribution channel 42a is the sum of D, the length of unlengthened distribution channel 42a, and d, the distance between connection node 40b and connection node 40a. Therefore, total channel length L_{b} for distribution channel 24b (corresponding to unlengthened distribution channel 42b, with an added open loop 26) can be calculated as:

L_{b}=D+d.

Accordingly, distribution channel 24b includes an open loop 26 of length d (or a plurality of loops whose total length is d).

According to some embodiments, at connection node 40c, a calculated total length L_{c} of distribution channel 24c is to result in equal flow rates between connection node 40c and SNDA device connection line 34 via each of distribution channels 24a to 24c. Using the aforementioned formula for series and parallel resistances, the equivalent resistance to flow between connection node 40c and SNDA device connection line 34 via parallel flow through distribution channels 24a and 24b is proportional to (D+3d)/2. Further noting that the flow rate via the section of distribution trunk channel 28 between connection node 40c and 40b (and thus through the combination of distribution channels 24a and 24b) is double the flow rate through distribution channel 24c, the total length L_{c} of distribution channel 24c that enables a uniform flow rate can be calculated to be:

L_{c}=D+3d.

Accordingly, distribution channel 24c includes one or more open loops 26 of total length 3d. It may be noted that the length of open loops 26 that are added to distribution channel 24c in this calculation for L_{c} of distribution channel 24c, as well as the calculations below for distribution channels 24d to 24f, differs from the number of open loops 26 shown in the general layout illustration in FIG. 1B, and which are based on a different calculation.

Similarly, according to some embodiments, at connection node 40d, a calculated total length L_{d} of distribution channel 24d is to result in equal flow rates between connection node 40d and SNDA device connection line 34 via each of distribution channels 24a to 24d. Using the aforementioned formula for series and parallel resistances, the equivalent resistance to flow between connection node 40d and SNDA device connection line 34 via parallel flow through distribution channels 24a through 24c is proportional to (D+3d)/3. Further noting that the flow rate via the section of distribution trunk channel 28 between connection node 40d and 40c (and thus through the combination of distribution channels 24a to 24c is triple the flow rate through distribution channel 24d, the total length L_{d} of distribution channel 24d that enables a uniform flow rate can be calculated to be:

L_{d}=D+6d.

Accordingly, distribution channel 24d includes one or more open loops 26 of total length 6d.

Similarly, according to some embodiments, at connection node 40e, a calculated total length Lₑ of distribution channel 24e is to result in equal flow rates between connection node 40e and SNDA device connection line 34 via each of distribution channels 24a to 24e. Using the aforementioned formula for series and parallel resistances, the equivalent resistance to flow between connection node 40e and SNDA device connection line 34 via parallel flow through distribution channels 24a through 24d is proportional to (D+6d)/4. Further noting that the flow rate via the section of distribution trunk channel 28 between connection node 40e and 40d (and thus through the combination of distribution channels 24a to 24d is quadruple the flow rate through distribution channel 24e, the total length Lₑ of distribution channel 24e that enables a uniform flow rate can be calculated to be:

Lₑ=D+10d.

Accordingly, distribution channel 24e includes one or more open loops 26 of total length 10d.

Finally (in the example shown), according to some embodiments, at connection node 40f, a calculated total length L_{f} of distribution channel 24f is to result in equal flow rates between connection node 40f and SNDA device connection line 34 via each of distribution channels 24a to 24f. Using the aforementioned formula for series and parallel resistances, the equivalent resistance to flow between connection node 40f and SNDA device connection line 34 via parallel flow through distribution channels 24a through 24e is proportional to (D+10d)/5. Further noting that the flow rate via the section of distribution trunk channel 28 between connection node 40f and 40e (and thus through the combination of distribution channels 24a to 24e is five times the flow rate through distribution channel 24f, the total length L_{f} of distribution channel 24f that enables a uniform flow rate can be calculated to be:

L_{f}=D+15d.

Accordingly, distribution channel 24f includes one or more open loops 26 of total length 15d.

According to some embodiments, this calculation can be continued in a similar manner for numbers of distribution channels 24 greater than six. When the number of distribution channels 24 is fewer than six, the calculation can proceed as described above until the lengths L of all distribution channels 24 have been calculated.

It may be noted that, when distribution channels 24 are arranged symmetrically about symmetry axis 30, calculations need be performed only on one side of symmetry axis 30. When symmetrically arranged, the calculated total lengths L of each pair of symmetrically arranged distribution channels 24 that are equidistant from symmetry axis 30 are identical to one another. In the event of an asymmetric arrangement of distribution channels 24, or where the distance between adjacent connection nodes 40 is not the same for all pairs of adjacent distribution channels 24, calculation may be modified in accordance with the asymmetric positions of distribution channels 24.

FIG. 3 schematically illustrates distribution channels of the right side of the symmetry plane of a multiplexed array of SNDA components, according to some embodiments of the invention, where the lengths of the channels being adjusted to enable a uniform flow rate.

According to some embodiments, in channel arrangement 46, a total length of each of distribution channels 24a to 24d is as calculated in the examples above. The length of each of distribution channels 24b to 24d includes one or more open loops 26. In the example shown, the length of each open loop 26 is equal to separation distance d. Therefore, the number of open loops 26 in each of distribution channels 24a to 24d is equal to the multiple of d that is added to channel minimum length D to yield total length L for each of distribution channels 24a to 24d.

For example, in accordance with the calculation above, distribution channel 24a includes no (zero) open loops 26, distribution channel 24b includes one open loop 26, distribution channel 24c includes three open loops 26, and distribution channel 24d includes six open loops 26. Identical numbers of open loops 26 can be included in distribution channels 24 that extend from distribution trunk channel 28 at positions that are symmetrical about symmetry axis 30 to those of distribution channels 24a to 24d.

It may be noted that a maximum distance between distribution trunk channel 28 and SNDA device connection line 34 can be limited by various considerations. Accordingly, there can be various reasons for limiting the number of open loops 26 that can be added to a distribution channel 24. Other considerations can limit a minimum size of d. Thus, the number of distribution channels 24 that extend from distribution trunk channel 28 may be limited. In the examples shown in FIGS. 1B and 3, the maximum number of open loops 26 that can be included in a single distribution channel 24 is limited to about six. In this case, if the added length is calculated as described above, no more than four distribution channels 24 can extend from distribution trunk channel 28 on either side of symmetry axis 30.

Alternatively, or in addition to adjusting a total length of each distribution channel 24, a cross section of each distribution channel 24 can be designed to enable substantially identical flow rates through all distribution channels 24. For example, channel arrangement in such a case can be similar to the arrangement of FIG. 2, where each unlengthened distribution channel 42 has a different cross section.

For example, results of a flow simulation may yield a width of each unlengthened distribution channel 42 required to provide identical flow rates through all of unlengthened distribution channels 42.

In one example simulation, the widths of unlengthened distribution channel 42a and of distribution trunk channel 28 were set to 150 μm (e.g., to match the width of primary channels 16), d was set to 2.35 mm, and D was set to 11 mm. In this simulation, the calculated widths ranged from 14 μm for unlengthened distribution channel 42b to about 10 μm for unlengthened distribution channel 42f. It may be noted that, in this example, the differences in width among unlengthened distribution channels 42b to 42f are small relative to the width of unlengthened distribution channel 42a. Different results can be obtained from simulations based on other dimensions.

According to some embodiments, the rectangular shape of multiplexed SNDA device 10 can enable connecting a plurality of component multiplexed SNDA devices 10 into a multi-array system. The multi-array system can include a single inlet port into which a fluid (e.g. liquid) is to be introduced to flow to all the component multiplexed SNDA devices 10 via an arrangement of feeder channels. Similarly, all secondary channels 20 can be connected to a single evacuation channel (e.g., having a rectangular form) to which negative pressure can be applied.

FIG. 4A schematically illustrates an example of channels of a system 51 of multiple multiplexed SNDA devices, according to some embodiments of the invention, where all SNDA devices 10a-10h are oriented parallel to one another.

In the example shown of channeling system 50, eight multiplexed SNDA devices 10a-10h, and their associated channel arrangements 46, are connected to a single input port 52. A fluid (e.g. liquid) that is introduced into channeling system 50 via input port 52 can flow from input port 52 to multiple channel arrangements 46 via feeder channels 54. Feeder channels 54 are configured such that the lengths of all paths from input port 54 to each of channel arrangements 46 are substantially identical. In the example shown, feeder channels 54 are arranged in a branched pattern in which all branches are of equal length.

According to some embodiments, a single evacuation channel (not shown), for example having a rectangular shape or a U-shape, can surround all of the multiplexed SNDA devices 10a-10h that are connected to input port 52, via feeder channels 54 and channel arrangements 46. According to some embodiments, the evacuation channel can include a single port via which negative pressure can be applied to all component multiplexed SNDA devices 10a-10h.

FIG. 4B schematically illustrates an example of channels of a system 61 of multiple multiplexed SNDA devices 10i-10l, according to some embodiments of the invention, where some SNDA devices are oriented perpendicularly to others.

In the example shown of channeling system 60, four multiplexed SNDA devices 10i-10l, and their associated channel arrangements 46a and 46b, are connected to a single input port 52. A fluid (e.g. liquid) that is introduced into channeling system 60 via input port 52 can flow from input port 52 to multiple channel arrangements 46a and 46b via feeder channels 62. In the example shown, feeder channels 62 are in the form of segments with resistance that can be substantially lower than the resistance at 46a and 46b entry port, ensuring that all feeding channels are filled prior to reaching the 46a,b complexes.

In the example shown, channel arrangements 46a are arranged opposite one another across input port 52. Similarly, channel arrangements 46b, each rotated 90° to channel arrangements 46a, are arranged opposite one another across input port 52.

According to some embodiments, a single evacuation channel (not shown), e.g., that is rectangular, can surround all of the multiplexed SNDA devices 10i-10l that are connected to input port 52 via feeder channels 54 and channel arrangements 46a and 46b. The evacuation channel can include a single port via which negative pressure can be applied to all component multiplexed SNDA devices 10i-10l.

According to some embodiments, other designs of a multiplexed SNDA device can be used.

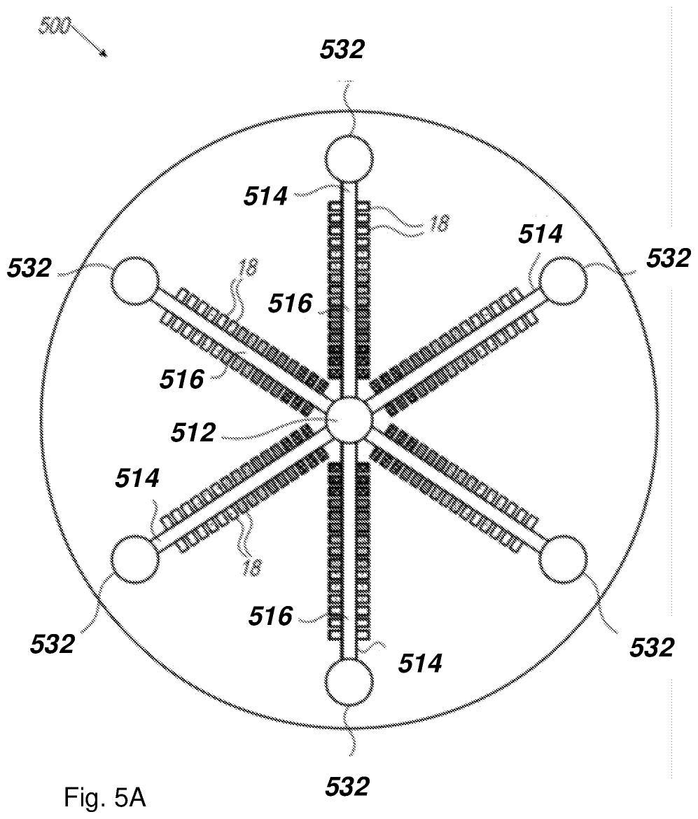

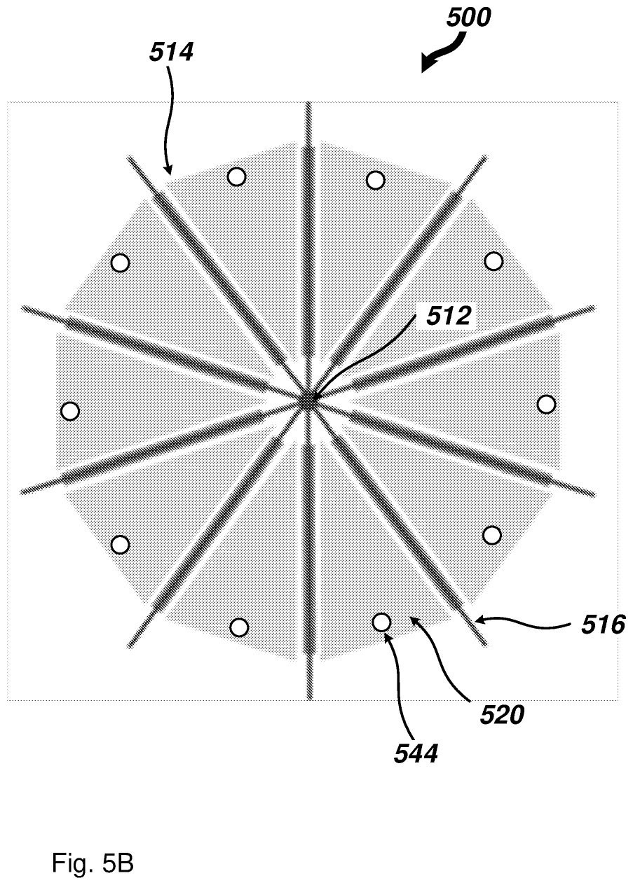

According to some embodiments of the invention and as demonstrated in FIGS. 5A and 5B, a device 500 is provided, comprising:
plurality of Stationary Nanoliter Droplet Array (SNDA) components 514; each SNDA component comprising: at least one primary channel 516; at least one secondary channel 520; and a plurality of nano-wells 18 that are each open to the primary channel and are each connected by one or more vents to the secondary channel; the vents are configured to enable passage of gas solely (e.g. air) from the nano-wells to the secondary channel, such that when a fluid (e.g. liquid) is introduced into the primary channel it fills the nano-wells, and the originally accommodated gas (e.g. air) is evacuated via the vents and the secondary channel/s; wherein the plurality of the SNDA components are aligned in a star-like configuration, such that the device comprises a circular form;
an inlet port 512 configured to enable a simultaneous introduction of the fluid (e.g. liquid) into all primary channels; and
at least one outlet port 544 and optionally an evacuation channel (not shown) configured to enable evacuation of the gas (e.g. air) out of all the secondary channels.

For example, and as shown in FIGS. 5A and 5B, a multiplexed SNDA device 500 can have a star-like shape, with a common inlet 512 located in the center of the star. SNDA components 514 may be arranged as rays extending outwards from common inlet 512, and separate individual inlets 532 are located at an end of primary channels 516 that is opposite to an end that is connected to common inlet 512. A plurality of nano-wells 18 are each open to their associated primary channel 516, and connected by one or more vents to their associated secondary channel 520 to enable passage of gas (e.g. air) from that nano-well 18 to the secondary channel, via the vent/s, when a fluid (e.g. liquid) that is introduced into the primary channel 516 and fills that nano-well 18. Other designs of multiplexed SNDA devices can be used. According to some embodiments, any one of the above mentioned or the following method steps can be applied to use the device 500 having the star-like configuration.

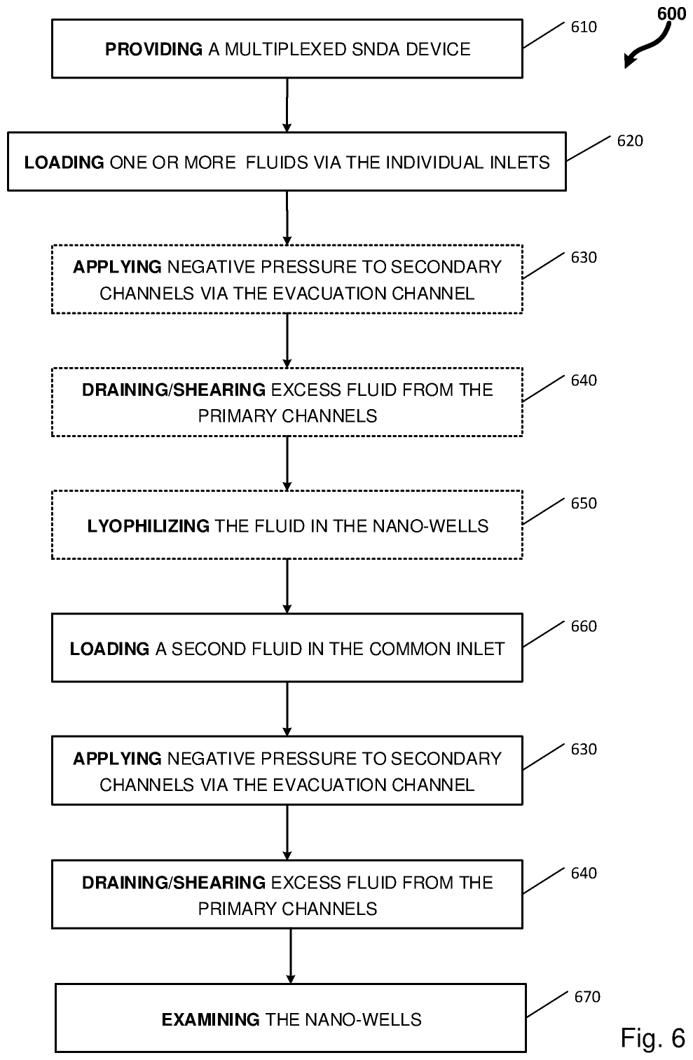

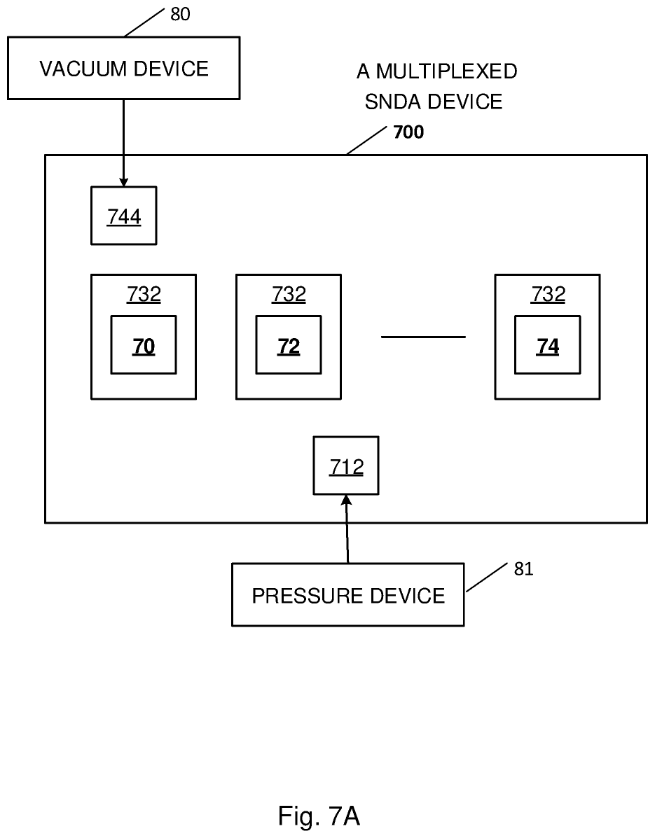

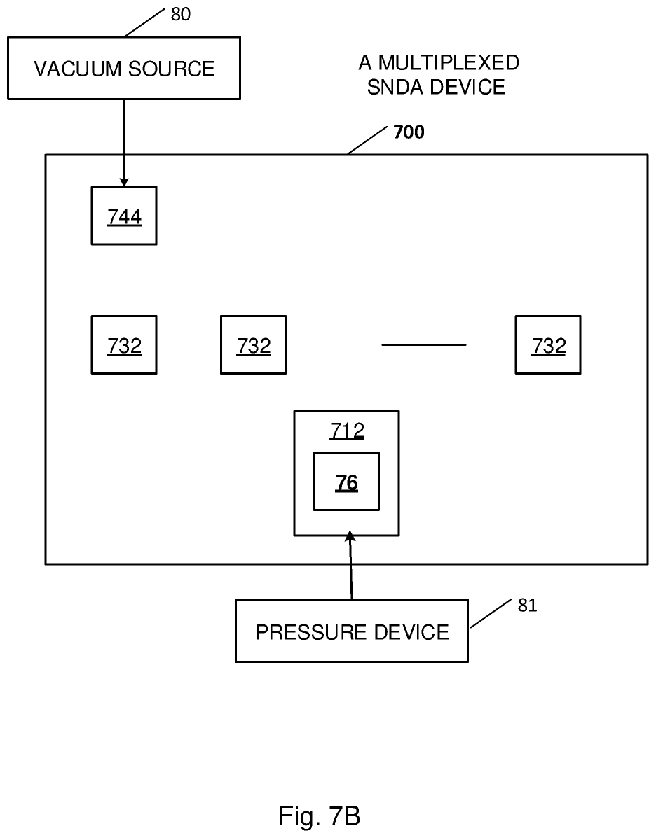

Reference is now made to FIG. 6, which demonstrates a flowchart of a method 600 for loading and using multiplexed SNDA devices, e.g., the multiplexed SNDA devices demonstrated in 10 FIGS. 1A-1C, 10a-10h FIG. 4A, 10i-10l FIG. 4B, 500 FIGS. 5A and 5B, 700 FIGS. 7A-7B and/or other any multiplexed SNDA device, according to various embodiments of the present invention.

According to some embodiments, in operation step 610 a multiplexed SNDA device is provided, according to any one of the above mentioned embodiments.

According to some embodiments, in operation step 620 a first fluid (e.g. liquid) is placed in one or more of individual inlets (32,532). According to some embodiments, different types of fluids are provided in the different individual inlets (32,532), to enable a conduction of different treatment (e.g. experiments) concurrently. For example, each fluid type can include a different antibiotic solution, reagent solution, control solution and any combination thereof.

According to some embodiments, in operation step 630, a negative pressure can be applied, during the first fluid and/or second fluid loading step/s, via the evacuation channel (22,544) and/or via the secondary channels (20,520), to facilitate flow of the fluid (e.g. liquid) that was placed in the individual inlets (32,532) to flow towards the primary channels (16,516) and into the plurality of nano-wells (18) that are open to the primary channel (16,516), by sucking out air via the vents of the nano-wells. According to some embodiments, after the loading step/s, the secondary channels are disconnected from the negative pressure, in order to equilibrate back to atmospheric pressure, configured to avoid a risk of pulling the droplets from the nano-wells into the secondary channel during a following shearing step.

FIG. 7A depicts an example of an SNDA device 700, according to some embodiments of the invention, loaded with different types of fluids (70, 72 and 74) that are placed in the plurality of the individual inlets 732. FIGS. 7A and 7B demonstrate an optional negative pressure device 80 (e.g., a syringe pump or other controllable vacuum source or suction device) that is configured to apply negative pressure via the outlet 744 of the evacuation channel (not shown in FIG. 7A and 7B). FIGS. 7A and 7B further demonstrate an optional positive pressure device 81 that is configured to apply positive pressure via the common outlet 712, optionally to the distribution channel (not shown in FIGS. 7A and 7B).

According to some embodiments and as further demonstrated in FIG. 6, in operation step 640, excess fluid (e.g. liquid) is drained or purged out of the primary channels (16,516), after the filling of the nano-wells 18. For example, excess fluid can be drained or purged by introducing shearing fluid, e.g., gas, air or oil, for example by applying positive pressure to primary channels (16,516), via their associated individual inlets (32,532,732), such that the excessive fluid is evacuated via the common inlet (12,512,712), or by applying a positive pressure to the primary channels via the common inlet (12,512,712), such that such that the excessive fluid is evacuated via their associated individual inlets (32,532,732); or alternatively or in combination with, applying negative pressure to primary channels (16,516,716), via their associated individual inlets (32,532,732), such that the excessive fluid is evacuated via the those individual inlets (32,532,732), or by applying negative pressure to the primary channels via the common inlet (12,512,712), such that such that the excessive fluid is evacuated via that common inlet (12,512,712).

According to some embodiments, in operations step 650, the fluid in nano-wells 18 can be treated, for a non-limiting example, the fluid can be lyophilized, e.g., to retain the antibiotic or reagent in nano-wells 18.

According to some embodiments, in operation step 660, a second fluid/liquid, e.g., a bacterial suspension or any sample liquid, is loaded via the common inlet (12,512).

According to some embodiments, operation step 630 is repeated, where same or a different negative pressure may be applied, via the evacuation channel (22,544) and/or the secondary channels (20,520), to facilitate flow of the second fluid that was loaded in the common inlet (12,512) to primary channels (16,516) and into the nano-wells (18).

According to some embodiments, operation step 640 is repeated, to drain or purge the excess of the second fluid/liquid out of the primary channels (16,516), wherein same or different positive and/or negative pressures may be applied.

FIG. 7B depicts the second fluid 76 that is loaded via the common inlet 712. For example, the second fluid can include a sample liquid, e.g., a bacterial suspension.

According to some embodiments, in operation step 670, nano-wells 18 can be examined and analyzed to determine the effect of the one or more types of the first fluids/liquids on the second fluid/liquid. According to some embodiments, the examination is provided via a system including a least one imaging device and at least one processor configured for the image analysis.

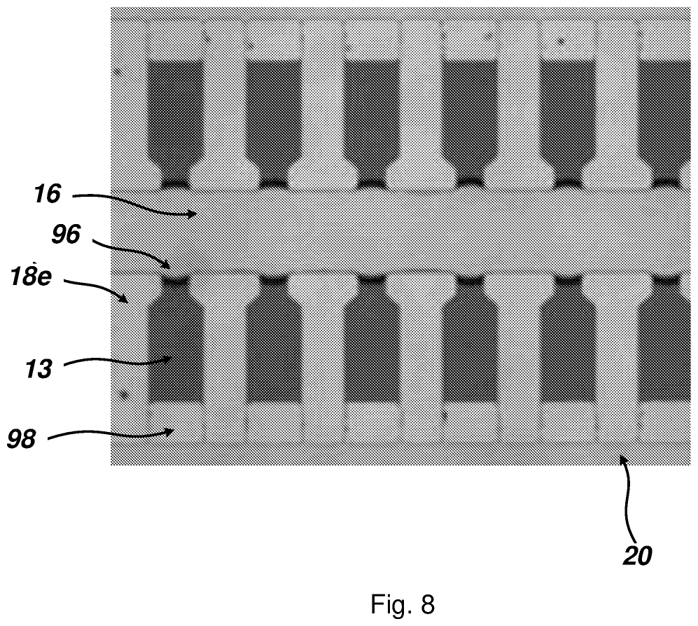

FIG. 8 demonstrates an image taken, via an imaging device, during the application of some of the above mentioned operation steps. FIG. 8 demonstrates sheared droplets 13 of fluid, trapped in the nano-wells 18e, after the primary channel 16 was evacuated from excessive fluid. FIG. 8 further demonstrates the nano-well arrangement 18e comprising a neck configuration 96 at the end, which is open towards the primary channel 16, according to some embodiments of the invention, and the short and wide window-like vent 98, according to some embodiments the invention.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A microfluidic device comprising:
plurality of Stationary Nanoliter Droplet Array (SNDA) components; each SNDA component comprising:
at least one primary channel;
at least one secondary channel; and
a plurality of nano-wells that are each open to the primary channel and are each connected via one or more vents to the secondary channel; the vents are configured to enable passage of gas solely from the nano-wells to the secondary channel, such that when a fluid is introduced into the primary channel it fills the nano-wells, and the originally accommodated gas is evacuated via the vents and the secondary channel/s;
a common inlet port, configured to enable a simultaneous introduction of the fluid into all the primary channels of the different SNDA components;
plurality of individual inlet ports, configured to enable individual introduction of fluid, each into a different primary channel of a different SNDA component; and
at least one outlet port, configured to enable evacuation of the gas out of all the secondary channels;
wherein
each of the nano-wells comprises a neck opening configuration at the end, which is open towards the primary channel, characterized by a ratio between the area of the nano-well's opening (S_{LG}) and the area of the nano-well's walls (S_{SL}); the ratio is configured to reduce an energy barrier for a droplet shearing, such that a sheared fluid is retained as a droplet within said nano-well.

2. (canceled)

3. The device of claim 1, wherein the ratio S_{LG}/S_{SL} is selected between about 0.4 and less than 1.0.

4. A microfluidic device comprising:
plurality of Stationary Nanoliter Droplet Array (SNDA) components; each SNDA component comprising:
at least one primary channel;
at least one secondary channel; and
a plurality of nano-wells that are each open to the primary channel and are each connected via one or more vents to the secondary channel; the vents are configured to enable passage of gas solely from the nano-wells to the secondary channel, such that when a fluid is introduced into the primary channel it fills the nano-wells, and the originally accommodated gas is evacuated via the vents and the secondary channel/s;
a common inlet port, configured to enable a simultaneous introduction of the fluid into all the primary channels of the different SNDA components;
plurality of individual inlet ports, configured to enable individual introduction of fluid, each into a different primary channel of a different SNDA component;
at least one outlet port, configured to enable evacuation of the gas out of all the secondary channels; and
a distribution channel in fluid communication with the common inlet, configured to enable a simultaneous introduction of the fluid into all the primary channels of the different SNDA components.

5. The device of claim 1, wherein at least one of the following holds true:
the device further comprising an evacuation channel in fluid communication with the outlet port, configured to enable a simultaneous evacuation of the gas out of the secondary channels of the different SNDA components;
at least one of the inlets and outlets is configured to enable an application of negative and/or positive pressure, via a pressure device;
the common inlet port is in fluid communication with one edge of the primary channel, while the individual inlet ports are in fluid communication with the other edge of their associated primary channel; and
the vents of the nano-wells comprise a short and wide window-like configuration.

6. The device of claim 4, wherein at least one of the following holds true:
the device further comprising an evacuation channel in fluid communication with the outlet port, configured to enable a simultaneous evacuation of the gas out of the secondary channels of the different SNDA components;
at least one of the inlets and outlets is configured to enable an application of negative and/or positive pressure, via a pressure device;
the common inlet port is in fluid communication with one edge of the primary channel, while the individual inlet ports are in fluid communication with the other edge of their associated primary channel; and
the vents of the nano-wells comprise a short and wide window-like configuration.

7. (canceled)

8. A method comprising the steps of:
providing a device comprising plurality of Stationary Nanoliter Droplet Array (SNDA) components; each SNDA component comprising: at least one primary channel, at least one secondary channel, and a plurality of nano-wells that are each open to the primary channel and are each connected via one or more vents to the secondary channel, the vents are configured to enable passage of gas solely from the nano-wells to the secondary channel, such that when a fluid is introduced into the primary channel it fills the nano-wells, and the originally accommodated gas is evacuated via the vents and the secondary channel/s; a common inlet port, and optionally a distribution channel, configured to enable a simultaneous introduction of the fluid into all the primary channels of the different SNDA components; plurality of individual inlet ports, configured to enable individual introduction of fluid, each into a different primary channel of a different SNDA component; and at least one outlet port, and optionally an evacuation channel, configured to enable a simultaneous evacuation of the gas out of all the secondary channels;
loading the nano-wells of at least one of the SDNA components, with at least one first fluid, via the individual inlet ports and their associated primary channel/s;
loading the nano-wells of all the SNDA components, with a second fluid, via the common inlet port and the primary channels;
examining the fluid droplets in the nano-wells; and
at least one step selected from the group comprising:
during the loading step/s of the first fluid and/or the second fluid, applying negative pressure to at least one of the secondary channels, via the outlet port/s, configured to enable gas evacuation out of the nano-wells, via the vents and the secondary channel/s;
after at least one of the loading steps, temporarily applying pressure to at least one of the primary channels, configured evacuate excessive fluid that has remained in the primary channel/s after filing the nano-wells;
treating the nano-wells' first fluid droplets, before the loading of the second fluid;
treating the nano-wells' droplets formed by the first- and second-fluids; and
examining is provided via an imaging device and at least one computing processor, wherein the examining, is configured to determine the effect of the first fluid on the second fluid.

9. The method of claim 8, wherein each of the loaded individual inlet ports is loaded with a different first fluid.

10. The method of claim 8, wherein the loading of the nano-wells of all the SNDA components with the second fluid is simultaneous.

11. (canceled)

12. (canceled)

13. The method of claim 8, further comprising after at least one of the loading steps, temporarily applying pressure to at least one of the primary channels, configured evacuate excessive fluid that has remained in the primary channel/s after filing the nano-wells, wherein a positive pressure is applied via:
the common inlet port, such that the excessive fluid in the primary channels is evacuated via the individual inlet port/s; or,
at least one of the individual inlet ports, such that the excessive fluid in the associated primary channel/s is evacuated via the common inlet port.

14. The method of claim 8, further comprising after at least one of the loading steps, temporarily applying pressure to at least one of the primary channels, configured evacuate excessive fluid that has remained in the primary channel/s after filing the nano-wells, wherein a negative pressure is applied via:
the common inlet port, such that the excessive fluid in the primary channels is evacuated via the common inlet port; or,
at least one of the individual inlet ports, such that the excessive fluid in the associated primary channel/s is evacuated via those individual inlet port/s.

15. (canceled)

16. The method of claim 8, further comprising treating the nano-wells' first fluid droplets, before the loading of the second fluid, wherein the step of treating comprising lyophilizing the nano-well's first fluid droplets.

17. The method of claim 8, further comprising treating the nano-wells' droplets formed by the initially treated—and optionally dried—first-fluid and the second-fluids.

18. The method of claim 8 or 17, wherein the step of examining is provided via an imaging device and at least one computing processor, configured to determine the effect of the initially treated—and optionally dried—first fluid on the second fluid.

19. (canceled)
